(19) United States
(12) Patent Application Publication
(10) Pub. No.: US 2004/0088286 A1
(43) Pub. Date: May 6, 2004

(54) System and method for enhancing network-based collaboration

(76) Inventors: David E. Hackleman, Monmouth, OR (US); William C. Wickes, Corvallis, OR (US)

Correspondence Address: HEWLETT-PACKARD COMPANY, Intellectual Property Administration, P. O. Box 272400, Fort Collins, CO, 80527-2400, US

(21) Appl. No.: 10/285,927

(22) Filed: Oct. 31, 2002

(51) Int. Cl. G06F 17/30

(52) U.S. Cl. 707/3

(57) ABSTRACT

A network-based collaboration system includes an interface subsystem that provides for a plurality of user interfaces that include a content supplier interface and a searcher interface. The system additionally includes a content subsystem that includes a storage component for storing records. The interface subsystem provides a searcher interface for receiving search criterion and a content supplier interface for receiving content. A search subsystem generates augmented search criterion from the search criterion received through the searcher interface. The search subsystem can then perform the search with the augmented search criterion.

### BACKGROUND OF THE INVENTION

This invention relates generally to a system and method for sharing information over a network.

Developments in computer networks have greatly enhanced the ability to store and retrieve information. In the modern economy, information-based assets are often a company's most valuable class of assets.

Despite the increased importance of information and despite technological improvements relating to the storage of information, existing tools are often inadequate with respect to the utilization of all the information that is stored. The general problem faced by many searchers of information is not the absence of the information, but rather the voluminous amount of irrelevant information that is often retrieved that hampers the efforts of the searcher. For example, it is difficult to collaborate with other researchers on a particular topic, when the information put forth by those other researchers is difficult to find due to voluminous libraries of extraneous information one has to sort through. Such difficulties are magnified by inconsistencies of terminology. These and other limitations are entrenched in the minds of researchers and other collaborators. Thus, such limitations are accepted as inevitable.

The linking of computers to other computers may be done using wide variety of different networking techniques. Each of the networking techniques provides inadequate means for searching for information, and collaborating with others. Search techniques relating to local area networks (LANs) focus on the information technology characteristics of a particular file, for example file type, file name, date updated, etc., instead of the content of a particular file. Search techniques relating to the Internet and the World Wide Web (collectively the “Web”) are hampered by the wide variety of words and phrases that can be used to describe a particular subject. Web techniques are also hampered by security issues and the affirmative decision-making required in deciding what is published, what is not published. Search techniques relating to intranets and extranets suffer from many of the same impediments to effective collaboration as the Web techniques do. It is not a practical solution to create duplicative copies of all emails, and load those copies onto the intranet or extranet. Moreover, such a solution would still fail to deal with the inherent limitations of conventional search engines or web crawlers.

Although web crawlers are created to search for information, web crawlers are inadequate collaboration tools. The ability to perform such searches is hampered by limitations in terminology as well as technology. If related research is being performed within a large company or organization, it is often difficult to conduct a meaningful search because internal research may not be published or is otherwise proprietary, as well as the proprietary nature of the research at other companies or organizations. Moreover, search results do not necessarily include a mechanism for direct communication option between the searcher and the content supplier of the information. Concerns about the disclosure of proprietary and confidential information have precluded the desire to create such tools, even though there are many instances in which such communication would not be objectionable by the parties in interest. It would be desirable for a search capability that can focus on user search parameters and automatically retrieve updated information based on predetermined search parameters enhanced applying intelligence to the search process.

### BRIEF DESCRIPTION OF THE DRAWINGS

The embodiments of the present invention will be described in detail, with reference to the following figures, wherein:

FIG. 1 is process-flow diagram illustrating an example of a process-flow that can be performed by a network-based collaboration system in accordance with an aspect of the invention.

FIG. 2 is block diagram illustrating an example of a hardware configuration that can be incorporated into various embodiments of the present invention of a network-based collaboration system.

FIG. 3 is a process-flow diagram illustrating an example of subsystem-level view of an embodiment of the present invention of a network-based collaboration system.

FIG. 4 is an example of a block diagram illustration of an embodiment of the present invention of a subsystem-level view of a network-based collaboration system that incorporates a search augmentation module, a security module, an administrator interface, and an administrator.

FIG. 5 is a flow chart illustrating one example of a search being performed according to an embodiment of the present invention of a network-based collaboration system.

### DESCRIPTION OF THE EMBODIMENTS

### I. Introduction of Elements

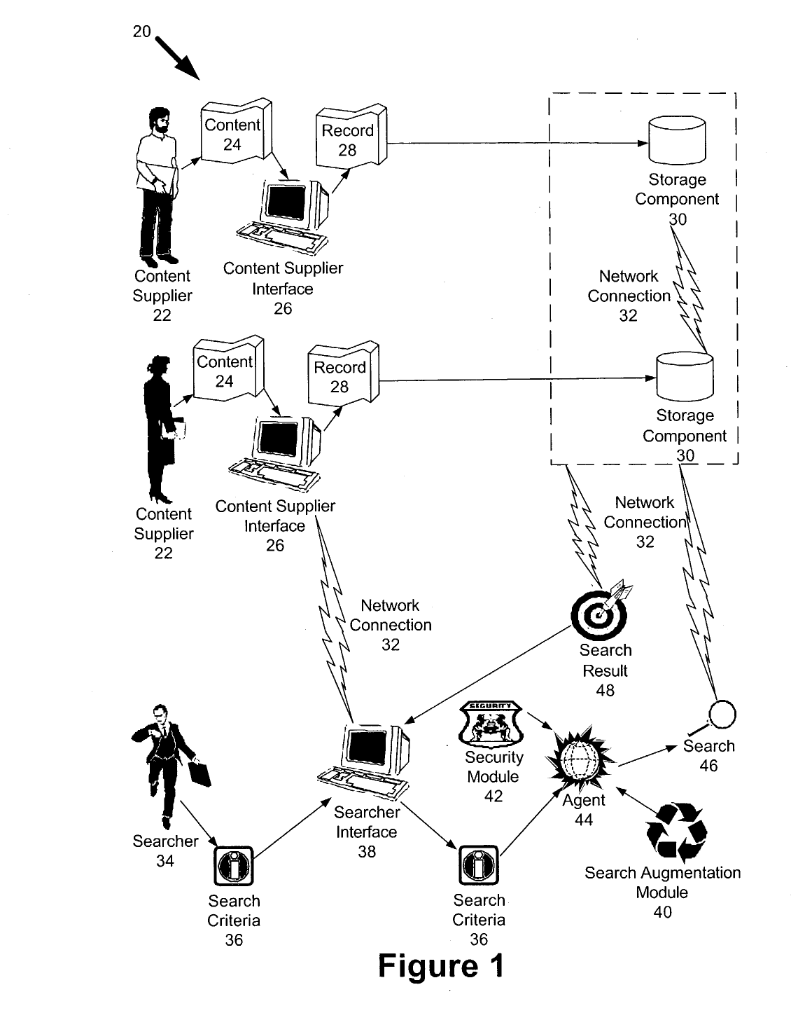

FIG. 1 is process-flow diagram illustrating an example of a process-flow that can be performed by a network-based collaboration system 20 (“collaboration system” or simply the “system”). The system 20 is highly adaptable and can incorporate a wide range of different structures, processes, and elements.

### A. Content Suppliers

One of the functions of the system 20 is to facilitate the exchange of information. The exchange of information requires a content supplier 22, for example content provider, supplier, source, and the like to provide information to the system 20. In many contexts, the content supplier 22 is a human being. However, other types of content suppliers 22 can be incorporated into the system 20. Robots, satellites, automated lab equipment, automated sensors, wireless devices, computers empowered with artificial intelligence, expert systems, and other types of devices can fulfill the functions of a content supplier 22. The system 20 can include a large number of content suppliers 22 and a wide variety of different content supplier types. In a company-wide embodiment of the system, every employee in the company can function as a content supplier 22. The system 20 can also be configured to include content suppliers 22 from different organizations. Due to limitations of space in FIG. 1, only two of many possible content suppliers 22 are shown.

### B. Content and Content Types

The information provide by the content supplier 22 can be referred to as content 24. Content 24 can exist in a wide variety of different content types such as: letters, words, or other text; ideas; facts; expressions; pictures; images; structures; designs; sounds; comments; opinions; impressions; concepts; communications; or any other form of information. The content supplier 22 inputs content into the system 20 by using content supplier interface 26.

### C. Content Supplier Interface

The content supplier interface 26 is typically a general purpose computer with a graphical user interface used for functions such as email, word processing, data base queries, and other task related applications. Any device capable of interfacing with a network can be a content supplier interface 26. Fax machines, scanners, cell phones, personal digital assistants (PDAs), embedded computers, programmable logic devices, sensors, and other devices can constitute content supplier interfaces 26. In many instances where a human being is not the content supplier 22, the content supplier 22 and the content supplier interface 26 can be the same device. In many embodiments of the system 20, a content supplier interface 26 is identified not by the particular device used to connect to the system 20 but by the identity of the content supplier 22. In alternative embodiments, content supplier interfaces 26 can be identified by device, or some other characteristic not related to the identity of the user.

### D. Records and Record Types

Information must be entered into the system 20 in such a format as can be stored and processed by a computer network. For example, no current device is capable of storing pure human thought. Thus, information is stored in a unit that can be referred to as a record 28. There is a wide variety of different record types that can incorporated into the system 20, such as: email; Web pages; data files; voice messages; application files such as word processing documents, spreadsheets, etc.; graphics files; sound files; video files; chat room transcripts; and any other type of file that is capable of being stored on a network.

In addition to the “content component” or substantive content 24, records 28 can also include information relating to the content supplier 22 that inputted the record 28, as well as other source-related data including means to contact the content supplier 22, such as an email address, a telephone number, a chat room location, etc. Records 28 can also include information such as a date-time stamp, an identifier relating to the content supplier interface 24 used by the particular content supplier 22, and potentially any other relevant characteristic.

In some embodiments of the system 20, records can be associated with a secrecy attribute limiting the ability of other users to access the particular record 28. Some secrecy attributes can be configured to permit or exclude access based on the identity of the searcher 34 attempting to access the record. Secrecy attributes can also be in the form of a numerical value, permitting comparison with an access attribute to determine whether access to a record 28 should be permitted in a particular circumstance. In some circumstances, the secrecy attribute can be set by the content supplier 22 providing the particular record 28. In those circumstances, the ranges in which the secrecy attribute can be set are limited to a range that corresponds with the authority of the particular content supplier 22. The system 20 can be configured to assign a secrecy attribute in an automated fashion in accordance with a set of secrecy rules. As described below, secrecy attributes and access attributes can be set in a wide variety of different ways.

### E. Storage Components and Storage Component Types

The system 20 stores records 28 in a storage component 30. A wide variety of different technologies can serve as storage components 30. In many embodiments, the storage component will be a database, including but not limited to a relational database or an object-oriented database. Other storage technologies can be used such as objects, flat files, arrays, and other data types. In many embodiments of the system 20, there will be numerous different storage components 30 and different types of storage components 30. For example, email functionality may utilize its own separate storage component, which will be different in type than the storage component for a computer housing an accounting application. All of the records 28 in the system 20 are stored in some form of storage component 30, and such information can come from a wide range of different content suppliers 22. Storage components 30 used by the system 20 are connected by a network connection 32. Different storage components 30 can be located on different networks, but storage components 30 of the system 20 should be accessible through at least one network connection 32. Thus, each device in the system 20 should be able to communicate with any other device in the system 20, through one or more network connections 32.

### F. Searcher

A searcher 34 is any person or object that requests the initiation of one or more searches. The searcher 34 is typically a human being. However, the variety of searchers 34 can vary as widely as the variety of different content suppliers 22. Thus, searchers 34 can be robots, satellites, automated lab equipment, automated sensors, wireless devices, computers empowered with artificial intelligence, expert systems, and other types of devices. Both content suppliers 22 and searchers 34 can be affiliated with one or more organizations. The system 20 can incorporate searchers 34 and content suppliers 22 from numerous different organizations to facilitate inter-organization and intra-organization collaboration. The searcher 34 in one context can be a content provider 22 in a different context. The searcher 34 can be a researcher requesting collaboration by using the system 20 or performing a search 46.

### G. Search Criteria

The content supplier 22 inputs one or more search criteria 36 that include the parameters of a search request. Search criteria 34 can include any characteristic that relates to the content 24 or “subject matter” of the records 28, such as a text string containing a chemical composition. Search criteria 36 can also include sophisticated combinations of characteristics, such as: X and Y; X and a word ending in Y; X within 3 words of Y; X and Y but not Z; X in all caps; the frequency of the number of times X is within the same paragraph as Y; etc. Search criteria 36 can also relate to non-substantive attributes, such as: a period of time; a depth of analysis; a source identifier; a geographic location; the identity of a content supplier 22; a number of repetitions; a date-time stamp; etc. Search criteria can include complex combinations of substantive and non-subject matter related characteristics.

### H. Searcher Interface

Searchers 34 enter search criteria 36 into the system 20 through the use of a searcher interface 38. The searcher interface 38 is typically a general purpose computer with a graphical user interface used for functions such as email, word processing, data base queries, and other task related applications. A searcher interface 38 in one context can be a content supplier interface 26 in a different context. Any device capable of interfacing with a network can be a searcher interface 38. Fax machines, scanners, cell phones, personal digital assistants (PDAs), embedded computers, programmable logic devices, sensors, and other devices can constitute searcher interfaces 38. In many instances where a human being is not the searcher 34, the searcher 34 and the searcher interface 38 can be the same device.

In many embodiments of the system 20, a searcher interface 38 is identified not by the particular device used to connect to the system 20 but by the identity of the searcher 34. In alternative embodiments, searcher interfaces 38 can be identified by device, or some other characteristic not related to the identity of the user.

### I. Agent

An agent 44 is the mechanism by which a search 46 is performed of the storage components 30. The agent 44 monitors records 28 in the system 20. The agent 44 can be used to monitor the work product of employees, connect content suppliers 22 working on similar projects, identify building blocks such as seed topics for subsequent activities, or otherwise uncover information relevant to the searcher 32. In the system, it is the agent 44, and not the searcher 34, the search criteria 36, or the searcher interface 38 that creates the search 46. In some embodiments, the agent 44 performs functionality without any human intervention. In some of those fully automated embodiments, the searcher interface 38 is not even notified of any differences between the search criteria 36 and the search that is performed 46. In other automated fully embodiments, the searcher interface 38 is notified of any differences. In embodiments not incorporating maximum automation, the searcher 32 can modify the search 46 generated by the agent 44. The system 20 can use multiple agents 44 simultaneously to perform the same or different searches. The agent 44 can incorporate the processing of a search augmentation module 40 and a security module 42 in generating and executing the search 46.

### J. Search Augmentation Module

The search augmentation module 40 enhances the search criteria 36 supplied by the searcher 34 in generating the search 46. One form of augmentation can include a lexicon of synonyms. The lexicon of synonyms augments the search criteria 36 by including additional equivalent search parameters to the search criteria 36 in an automated fashion. The same or roughly equivalent substantive meaning can be conveyed in many different ways. Thus, text searching may miss relevant records 28 due solely to word choice. For example, the words “process” and “function” are substantially equivalent in many contexts. The lexicon of synonyms can be configured to treat the terms as synonymous in those circumstances, while different in other circumstances. The lexicon of synonyms can be filled from a wide variety of different sources. In certain circumstances, the searcher 34 can add, delete, or modify to the content of the lexicon of synonyms. In other contexts, content suppliers 22 with substantial expertise can also be used to add, delete, or modify entries in the lexicon of synonyms. The system 20 itself can add, delete, or modify entries in the lexicon of synonyms based on expert system logic, analysis of past searches, and other automated techniques that support adding, deleting, or modifying the search criteria 36. In some embodiments, specially designated administrators are ultimately responsible for maintaining the lexicon of synonyms with respect to particular subject areas.

Other forms of search augmentation involve more than simply changing search criteria 36 on the basis of similar search parameters. Sophisticated expert systems can be incorporated into the system 20 to create searches 46 with a greater degree of independence from general parameters of the search criteria 36. An analysis of past searches 46, including but not limited to a statistical relevancy analysis coupled with searcher 34 feedback, can be used to augment the creation of a search 36.

Search augmentation can also include augmentation in the way that a search result 48 is reported back, displayed, or formatted. For example, if a searcher 34 from a particular department typically wants information displayed in a particular format or sequence, the search augmentation module 40 can perform such functionality.

Automated subsequent communications can also be part of the augmentation process. For example, a communication can be automatically sent to the content supplier interface 26 from the search interface 38 through a network connection 32.

### K. Security Module

Some embodiments of the system 20 may incorporate security functionality to limit the records 28 that a particular search 46 is permitted to include as a search result 48. As discussed above, certain records 28 can simply be declared off limits for all searches 46. Inclusion of records 28 in the search result 48 can also be based exclusively on the identity of the searcher 34. For example, the search result 46 could include a particular record 28 if the searcher 34 is the CEO of an organization, but omit the record 28 if the searcher 34 is a temporary worker. The inclusion of records 28 in the form of a search result 48 can also be based on a weighing of the need for secrecy against the need for access. As discussed above, the necessity of secrecy for a particular record 28 can be incorporated into the record 28 as a secrecy attribute. As was also discussed above, the importance of providing access to a particular record 28 is an access attribute of the search 46. Typically, the secrecy attribute is related to the subject matter involved and the access attribute is related to the searcher 34 desiring the information. An access determination can be reached by comparing the secrecy attribute to the access attribute. Access attributes and secrecy attributes can be generated automatically by the system 20 based on predefined security rules.

### L. Search

The search 46 as described above is actually performed by one or more agents 44. Once initiated, searches 46 can be configured to be periodically updated in an automated fashion without human intervention. Subsequent searches can also be facilitated in advance by creating and defining a seed topic as a search 46. A seed topic is a search criterion 36 that is created before records 28 relating to the topic are created. Searches 46 can target any characteristic relating to a record 28, including any characteristic that can be included in search criteria 36.

### M. Search Results

A search result 48 can be provided in a wide variety of different forms. In some embodiments, a database is populated with all records 28 included in the search results 48 relating to a search 46. In other embodiments, a link to the particular records 28 is passed along as the search result 48. Regardless of the storage and retrievals mechanisms, the searcher interface 38 can receive all of the search results 48. In many embodiments, search results 48 can include emails. In some of those embodiments, search results 48 may include one or more corresponding threads of emails. Search results 48 can be evaluated for relevancy with respect to the search criteria 36, the augmented search criteria, or other relevant benchmarks. Such a relevancy evaluation can be used by the augmentation module 40 to improve the future transformations of search criteria 36 into augmented search criteria.

The system 20 can include a component for redacting certain information that would otherwise be part of the search results 48. A search redaction module or component can filter search results on the basis of previously known interactions. For example, if the searcher 34 is already in constant or recent communication with content suppliers 22 experienced on web-based systems, then the system 20 can be configured to recognize that these communications already exist and exclude those content records from the search results. The search redaction module can be configured to function automatically and without human intervention.

### N. Subsequent Processing

As discussed above, the search augmentation module 40 can facilitate subsequent user-initiated process processes or can automatically initiate subsequent processes without human intervention. For example, communications between the searcher interface 38 and the relevant content supplier interface 26 can be automatically sent without human intervention through the network connection 32. In some embodiments, automatic notifications can be sent to the content supplier 22 whose record 28 appears in search results 48.

### II. Hardware View

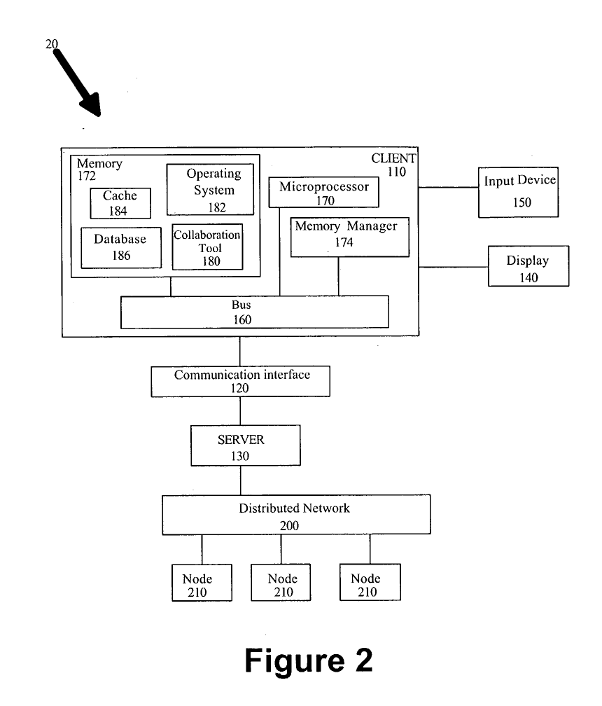

FIG. 2 is block diagram illustrating an example of a hardware configuration that can be incorporated into various embodiments of a network-based collaboration system 20 in accordance with various embodiments of the present invention.

The system 20 can access and retrieve data, such as records 28, from a remote block of a distributed network 200, such as an intranet, extranet, LAN, WAN, the Internet, or some other form of network 200 or various interlinked combinations networks 200.

The system 20 can include a client 110 and a communications interface 120 connected to a server 130. The client 110 will typically be a Windows 2000®, Windows NT®, Macintosh®, UNIX®, or Linux® platform computer, or any other programmed general purpose computer. In alternative embodiments, embedded computers, and other non-general purpose computers can be incorporated into the system 20. The communications interface 120 can be used to establish a communications link between the client 110 and the server 130. Content supplier interfaces 26 and searcher interfaces 38 are clients 110. If the system 20 incorporates an administrator interface, such a device is also typically a client 110.

The communications interface 120 may be any device that allows communications signals to pass between the client 110 and the server 130. The communications interface 120 may be a network card, a dial-up modem, a cable modem, a wireless interface, or any other type of communications connector.

The server 130 may also be implemented on a programmed general purpose computer, and can also be implemented on a special purpose computer, a programmed microprocessor or microcontroller and peripheral integrated circuit elements, an ASIC or other integrated circuit, a digital signal processor, a hard wired electronic or logic circuit such as a discreet element circuit, a programmable logic device such as a PLD, PLA, FPGA or PAL, or the like.

The client 110 can also be connected to a display device 140. The display device 140 may be a CRT monitor, an LCD monitor, a projector and screen, a printer, or any other device that allows a user to visually observe images. The display device 140 may also be any device that allows a visually impaired user to observe via tactile or aural interface.

The client 110 can also be connected to an input device 150. The input device may be one or more of a keyboard, a pointing device, an audio receiver, or any other device that allows a user to input information to the client 110.

The client 110 contains a bus 160 connecting a processor 170, a memory 172 and a memory manager 174. The memory 172 includes the storage components 30 of the system 20.

As shown in FIG. 2, the memory 172 is preferably implemented using static or dynamic RAM. However, the memory 172 can also be implemented using one or more of static RAM, ROM, flash memory, hard disk drive, CD-ROM drive, Floppy Disk Drive, Network Servers or the like. The memory manager 174 is generally a program for determining how best to allocate information in the memory 172. Caches may be created in the memory 172, resulting in a cache portion 184. A cache is a portion of memory in a computer used for the rapid access of information, and is also known as a fast storage buffer. The memory manager 174 determines routing of information between different memory types. For example, the memory manager 174 is used to determine which information is routed to the caches 184, or the hard disk or other memory storage device. The cache portion 184 of memory 172 is normally faster than an uncached portion of memory. For example, RAM may be used as cache to the uncached hard disk. In the search engines incorporated into the system 20, the cache can be either in RAM or hard disk.

As shown in FIG. 2, the processor 170 is preferably implemented on a programmed general purpose computer. However, the processor 170 can also be implemented on a special purpose computer, a programmed microprocessor or microcontroller and peripheral integrated circuit elements, an ASIC or other integrated circuit elements, a digital signal processor, a hard wired electronic or logic circuit such as a discreet element circuit, a programmable logic device such as a PLD, PLA, FPGA or PAL, or the like. In general, any device, capable of implementing a finite state machine that is in turn capable of implementing the process flows and programming logic identified both above and below, can also be used to implement a processor 170.

The memory 172 stores a collaboration tool 180 and an operating system 182. The operating system 182 can be any computer operating system known in the art, including DOS®, OS/2®, WINDOWS®, LINUX and UNIX. The network collaboration tool (“collaboration tool” or simply “tool”) 180 retrieves pages or data files from the nodes, or web sites 210. As shown in FIG. 1, a searcher 34 inputs search criteria 36 to the collaboration tool 180, and the collaboration tool 180, through the communications interface 120 and the server 130, accesses the network 200. The network 200 may be part of a local area network (LAN), a wide area network (WAN), the Internet, an intranet, an extranet, or any other type of network 200 capable of using network connections 32 to exchange information between two or more devices as described both above and below.

When the collaboration tool 180 retrieves information that satisfies the user search criteria 36 from the nodes 210, the information is transferred to the client memory 172. The information may be stored in the cache portion 184 of the memory 172 or in other non-cache portions of the memory 172.

In general, the collaboration tool 180 is a computer program that allows a searcher 34 to search and retrieve articles, memos, emails, web pages, document and data files (such as WORD® files, EXCEL® files, POWERPOINT® files, etc.) and other types of records 28 from predetermined sources based on predetermined parameters, such as search criteria 36 and augmented search criteria. The predetermined parameters may include subject, date, author, company, organization, type of company or organization, or any other information that would retrieve the information sought after by the user. The collaboration tool 180 may be written in any computer programming language compatible with the operating system used, and can be programmed using, for example, object-oriented design or linear programming techniques.

The collaboration tool 180 can utilize an automated collaboration discovery agent that addresses the problem in large organizations, for example, corporations, government and academia, where duplication of effort results in loss of efficiency due to multiple groups working on interrelated problems or tasks without the benefit of knowledge gained by related results. The collaboration tool 180 addresses this problem by recognizing and retrieving intra-group communications. These search results can then be “published” or otherwise made available to all participants in the various disparate working groups, or distribution can be limited to the requestor or other interested party.

By way of example, if a team in a large automobile corporation is developing improved braking systems, a member of the team might generate search parameters that routinely and periodically searches the company intranet for other related work that might be of interest to the team, for example, another team or department is developing improved brake linings at a location thousands of miles away in a division of the company that makes automobiles for racing. More simply, there can be two teams working independently on related projects. In the ordinary course of a project, team members exchange emails to communicate their progress, problems and solutions to other members of the team. The collaboration tool 180 can monitor these emails and use various keyword or content identification algorithms to recognize that there is a common interest between the two disparate teams. Thus, the collaboration tool 180 can be used to unite researchers and save the company money in duplicative work. This is accomplished by having the collaboration tool 180 prowl within various communications based on predetermined search parameters such as augmented search criteria generated by the system 20. The collaboration tool 180 becomes a discovery agent or literature and knowledge search engine that compares communication data streams for like content and interest based on the predetermined parameters. Users, both searchers 32 and contents suppliers 22, can register with the collaboration tool 180 to request notification of content updates. Similarly, users can opt out of update notification. Users can decide whether or not to follow-up by contacting the other identified users or teams. Accordingly, individuals or users working in a particular field or activity would be made aware of other individuals or users working in like fields.

As another example, internal corporate technical report databases can be searched for reports covering predetermined search parameters, and that data used to identify other individuals or teams having a common interest. Data streams suitable for searching by the collaboration tool 180 include intra-organization email, papers, internal publications and reports transmitted to a central repository, telephone calls, voice mail, news items and literature, and any other searchable database.

As another example, a professor or researcher at a University can utilize the collaboration tool 180 to periodically poll other specific servers, web sites, and the like for advanced publication of related research being performed at other universities or institutions, both public and private, or, similarly, search the entire field periodically on the World Wide Web. Similarly, a researcher at a branch campus of a large university can limit the search to any or all of a particular department or campus.

Accordingly, the collaboration tool 180 is an automatic search tool, and a user can specify at least the period of the search, search location parameters, and search criteria parameters. The collaboration tool 180 can also augment the search criteria 36 as described above.

In many corporations, email correspondence is not private, and the collaboration tool 180 can be set to open the company email system and look for email traffic on a topic, and filter those emails that the user who requested the search did not receive. A privacy option can be built in to alert the email originator of the email intercept, or email request, giving the email originator the option to make that email or its thread available or unavailable. Additionally, when a particular email satisfies the search criteria, the collaboration tool 180 can optionally be set to retrieve other emails on the same thread, or response/reply/forward path.

Accordingly, the collaboration tool 180 is an alternative to so-called chat rooms and message boards, which are cyber communication centers where users having a common interest write emails or send instant messages to each other on a topic common to the particular chat room.

The collaboration tool is preferably a program that receives user defined search parameters and searches predetermined locations for information in accordance with the search parameters. In one embodiment, the collaboration tool searches a company's emails for all emails related to the search parameters and retrieves all emails found as a result of the search. The retrieved emails can be stored at a specified memory, and may or may not be sent to the user. A notification that their emails were retrieved as a result of a search may or may not be sent to the author of the retrieved emails.

In yet another embodiment of this invention, the collaboration tool 180 contains a timer that can be set by a user to periodically run the search parameters to determine if there are emails retrieved based on the predetermined search criteria that are more recent than the previously retrieved emails. In this manner the collaboration tool only needs to retrieve the portion of emails that were not retrievable during the previous search. The timer can also sunset the search based upon user input.

### III. Subsystem-Level View

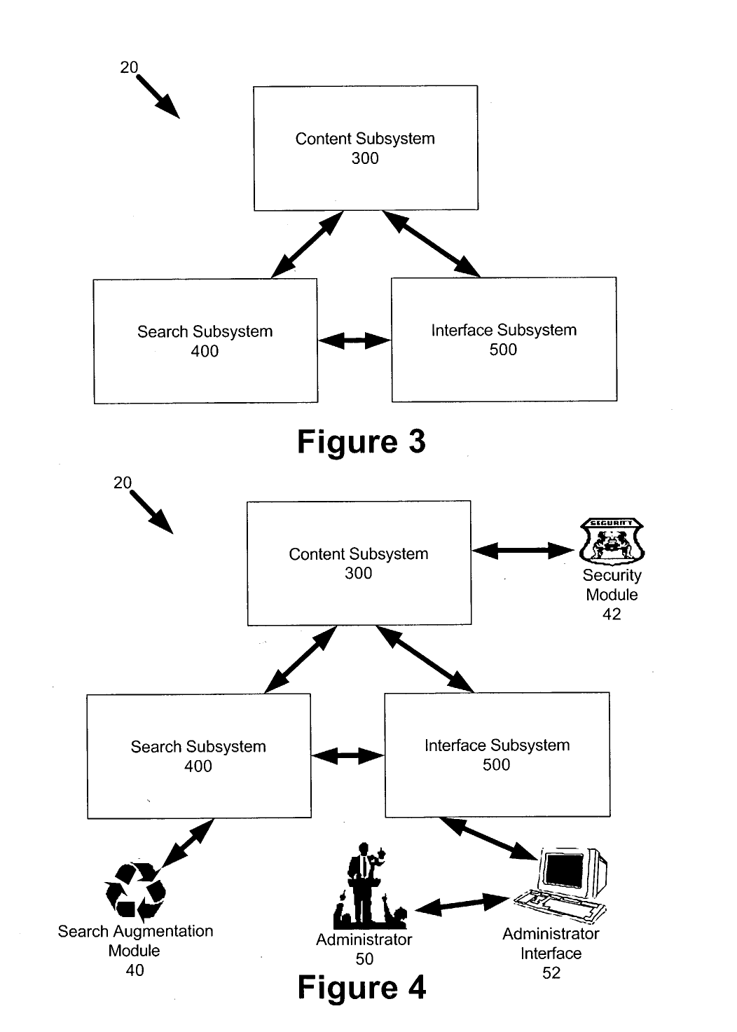

FIG. 3 is a process-flow diagram illustrating an example of subsystem-level view of a network-based collaboration system 20 in accordance with an embodiment of the present invention. As illustrated in the Figure, the system 20 can include three subsystems in facilitating collaboration of communication across one or more networks 200. Processing from any one of the three subsystems can result in subsequent processing by any of the other subsystems. FIG. 4 is a related block diagram, illustrating another embodiment of a subsystem-level view that includes components such as a search augmentation module 40, a security module 42, an administrator interface 52, and an administrator 50.

### A. Content Subsystem

A content subsystem 300 can include the network 200 itself, and the storage components 30 used to store the records 28. The content subsystem 300 can be responsible for all functionality necessary for storing and maintaining data. The content subsystem 300 can support a wide variety of record types and content types, as discussed above. Secrecy attributes for some or all of the records 28 can be set and processed by the content subsystem 300.

### B. Interface Subsystem

An interface subsystem 500 can be used by the system 20 to process all user-related interactions. Searchers 34, content suppliers 22, and other users such as administrators 50 interact with the system 20 through the interface subsystem 500. Administrators 50 interact with the system 20 through an administrative interface 52. The interface subsystem 500 is used by searchers 34 to initiate searches 46 and enter search criteria 36. In some embodiments, administrators 50 can use the administrator interface 52 of the interface subsystem 500 to define the security processing performed by the security module 42 and define the logic performed by the search augmentation module 40. The administrator interface 52 can also be configured to add, remove, or modify the rights of others to access the system 20.

### C. Search Subsystem

A search subsystem 400 can be used by the system 20 to find desired information amongst the totality of information stored in the system 20. The search subsystem 400 receives search criteria 36 from the searcher interface 38. Search augmentation can then be performed on the search criteria 36 by the search augmentation module 40 of the search subsystem 400. Notifications of the performed search can automatically be sent to the content supplier 22 in order to facilitate future collaboration and cooperation. As discussed above, in creating the search 46 to be performed by the system 20, the agent 44 can augment the search criteria 36 with the search augmentation module 40.

### IV. Process Flow

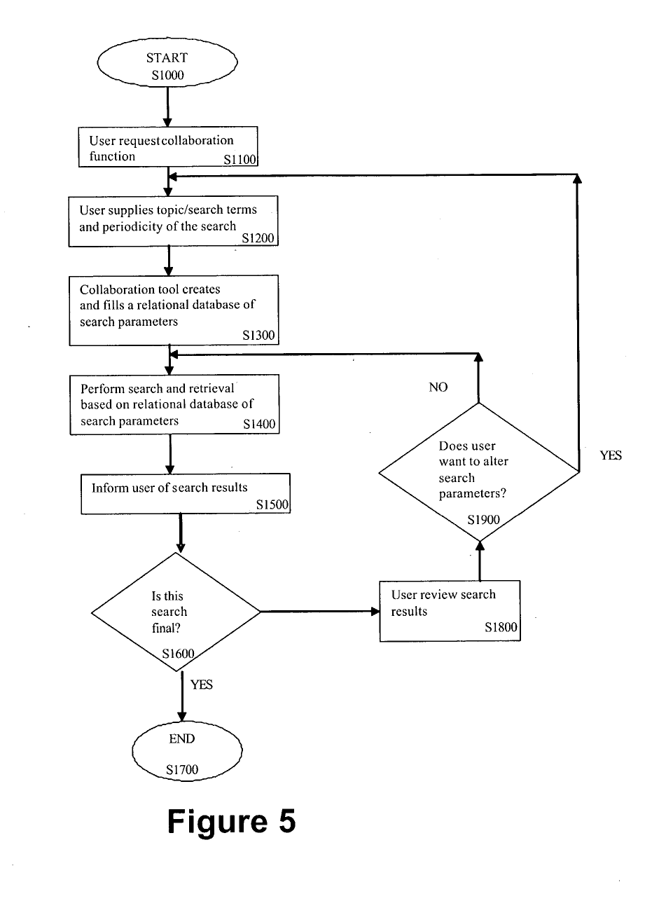

FIG. 5 is a flow chart illustrating another embodiment of a search being performed using a network-based collaboration system 20 in accordance with the present invention.

The method begins at step S1000, and continues to step S1100. In step S1100, the searcher 34 requests collaboration function, and the process continues to step S1200. In step S1200, the searcher 34 selects or supplies topic/search parameters and variables in the form of search criteria 36. Next, in step S1300, the collaboration tool 180 generates a relational database of the search parameters in the form of augmented search criteria as described above. Next, in step S1400, the collaboration tool performs the search and retrieval of information based on the augmented search criteria stored in the relational database.

In step S1500, the searcher 34 is informed of the search results. The system 20 can also be configured to automatically notify certain content suppliers 22 of the search results if the search results 48 would be useful to those content suppliers 22. If the result of the query in step S1600 whether this is the final search based on the user specified periodicity is yes, the process continues at step S1800. At step S1800, the searcher 34 reviews the search results from step S1500. The searcher 34 determines in step S1900 whether the search parameters need to be modified. If the search parameters need to be modified, the process continues at step S1200. If the search parameters do not need to be modified, the process continues at step S1400.

Using the search results, the user may identify other users who might be interested in the search results, and the collaboration tool can be set to forward the search results to those other users

The above description assumes an open database, for which most, if not all, communications are available for searching purposes. The collaboration tool 180 can also be restricted to search only those databases that it is given access to, that is, databases, communications and communications threads, and the like can be restricted from searching by any one of authors, supervisors, security personnel and the like. This might be desired to protect privacy, for internal or national security purposes, and the like. While the most comprehensive implementation of the collaboration tool 180 would be full automated analysis of all phone calls, file transfers, emails and the like within an organization, some potential safeguards include, for example, making participation in a program using the collaboration tool voluntary and selectable, or selectively blocking access by the collaboration tool, permitting the collaboration tool 180 access only to those emails, voicemails, etc. that are copied to an address that represents collaboration, or to limit access by the collaboration tool 180 to documents that are submitted to a central depository.

When users can limit access by the collaboration tool 180, there can also be supervisory or security overrides available to bypass individual lockouts. This may be necessary to ensure maximum benefit of the collaboration tool 180 and to ensure that proprietary information and national security information is safeguarded. Still further, the collaboration tool, when used in a large institutional setting such as the government or multinational corporations, can have safeguards limiting access to restricted information, in order to avoid violations of various laws, for example, unfair trade practices, the antiracketeering statute (18 U.S.C. 1951-1968), which includes the Racketeer Influenced and Corrupt Organizations Act (RICO), International Traffic in Arms Regulations (ITAR) and espionage (corporate and state sponsored).

It will also be understood that the collaboration tool 180 can also be a series of automated collaboration discovery agents, each operating for a specific collaboration set, allowing for more than one collaboration tool operating at any one time.

While the invention has been specifically described in connection with certain specific embodiments thereof, it is to be understood that this is by way of illustration and not of limitation, and the scope of the appended claims should be construed as broadly as the prior art will permit.

What is claimed is:

1. A network-based collaboration system, comprising:
an interface subsystem, providing for: a plurality of user interfaces comprising a content supplier interface and a searcher interface;
a content subsystem, providing for: a plurality of records and a storage component, wherein at least one said record in said plurality of records is created through said content supplier interface, and wherein said plurality of records are stored in said storage component; and
a search subsystem, providing for: receipt of a search criterion from said searcher interface, an agent, an augmented search criterion generated by said agent from said search criterion, a search performed by said agent from said augmented search criterion, and a search result retrieved by said agent from said content subsystem and said search.

2. The system of claim 1, wherein said search result includes at least one said record created through said content supplier interface, and wherein said searcher interface notifies said content supplier interface of said search.

3. The system of claim 1, wherein said search subsystem further provides for a lexicon of synonyms, wherein said augmented search criterion is generated with said lexicon of synonyms.

4. The system of claim 3, wherein said content supplier interface contributes to said lexicon of synonyms.

5. The system of claim 3, wherein said searcher interface contributes to said lexicon of synonyms.

6. The system of claim 3, wherein said interface subsystem further provides for an administrator interface that is not said content supplier interface and is not said searcher interface, and wherein said administrator interface contributes to said lexicon of synonyms.

7. The system of claim 3, wherein said agent automatically contributes to said lexicon of synonyms.

8. The system of claim 1, wherein said search subsystem further provides for a past search result, wherein said augmented search criterion is created with said past search result.

9. The system of claim 1, further comprising a secrecy attribute, an access attribute, and an access analysis;
wherein at least one said record comprises said secrecy attribute;
wherein said search comprises said access attribute; and
wherein said search subsystem provides for generating said access analysis by comparing said access attribute with said secrecy attribute.

10. The system of claim 9, wherein said content supplier interface provides for setting said secrecy attribute.

11. The system of claim 9, wherein said search interface provides for setting said access attribute.

12. The system of claim 9, further comprising a first organization, a second organization, wherein said interface subsystem further includes an administrator interface not affiliated with said first organization and said second organization, wherein said first organization generates at least one said record in said plurality of records, wherein said second organization generates said search criterion, and wherein said administrator interface generates said secrecy attribute and said access attribute.

13. The system of claim 12, further comprising a set of security rules, wherein said administrator generates said secrecy attribute and said access attribute in accordance with said set of security rules.

14. The system of claim 1, wherein said augmented search criterion is created without human intervention.

15. The system of claim 14, wherein said agent performs said search from said augmented search criterion without human intervention.

16. The system of claim 1, wherein said content subsystem further provides for a plurality of record types, wherein each said record in said plurality of records belongs to at least one said record type from said plurality of record types.

17. The system of claim 16, wherein said plurality of record types includes at least two of an e-mail, a web page, and a data file.

18. The system of claim 16, wherein said plurality of record types further includes a chat room transcript.

19. The system of claim 1, wherein said content subsystem further includes a plurality of content types, wherein each said record in said plurality of records belongs to at least one said content type from said plurality of content types.

20. The system of claim 19, wherein said plurality of content types includes at least two of a text string, a graphic, and a sound.

21. The system of claim 1, wherein each said record in said plurality of records includes an author identifier and a content component.

22. The system of claim 21, wherein said search includes a source identifier.

23. The system of claim 1, wherein said search includes a depth of analysis.

24. The system of claim 1, wherein said search includes a time period.

25. The system of claim 1, wherein said search is a seed topic.

26. The system of claim 1, wherein said result is a plurality of correspondence paths.

27. The system of claim 1, wherein said searcher is operated by a researcher requesting collaboration.

28. The system of claim 1, said plurality of user interfaces further comprising an administrator, wherein said administrator adds a user.

29. The system of claim 1, wherein said searcher subsystem further includes a collaboration tool, wherein said collaboration tool is a computer program.

30. The system of claim 1, wherein said searcher subsystem further includes a search redaction module.

31. A method for network-based collaboration, comprising:
requesting collaboration function of a collaboration tool;
supplying a search parameter to the collaboration function, the search parameter comprising at least one of topic, search term and periodicity of the search;
creating and filling a relational database of the search parameter;
performing search and retrieval based on said relational database of the search parameter to yield a search result;
informing the user of the search result; and
if this is a final search, terminating the search.

32. The method of claim 31, further comprising:
reviewing the search result;
determining if the search parameter should be altered;
if the search parameter is to be revised, revising the search parameter to the collaboration function, the revised search parameter comprising at least one of topic, search term and periodicity of the search, revising the relational database and performing another search and retrieval based on the revised relational database; and
if the search parameter is not to be revised, performing another search and retrieval.
